(19) United States
(12) Patent Application Publication
(10) Pub. No.: US 2009/0153748 A1
(43) Pub. Date: Jun. 18, 2009

(54) Apparatus and Method for Sensing an ATSC Signal in Low Signal-To-Noise Ratio

(76) Inventors: Wen Gao, West Windsor, NJ (US); Paul Gothard Knutson, Lawrenceville, NJ (US); Joshua Lawrence Koslov, Hopewell, NJ (US)

Correspondence Address: Thomson Licensing LLC, P.O. Box 5312, Two Independence Way, PRINCETON, NJ, 08543-5312, US

(21) Appl. No.: 12/084,450

(22) PCT Filed: Nov. 1, 2006
(86) PCT No.: PCT/US2006/042848

§ 371 Date: May 1, 2008

Related U.S. Application Data
(60) Provisional application No. 60/733,713, filed on Nov. 4, 2005.

(51) Int. Cl. H04N 5/50; H04N 17/00

(52) U.S. Cl. 348/732; 348/180; 348/E05.097; 348/E17.001

(57) ABSTRACT

A Wireless Regional Area Network (WRAN) receiver includes a tuner for tuning to one of a number of channels, and a broadcast ATSC (Advanced Television Systems Committee) signal detector. The tuner is calibrated as a function of a received ATSC signal. The broadcast ATSC signal detector can be a coherent or a non-coherent ATSC signal detector.

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

A Wireless Regional Area Network (WRAN) system is being studied in the IEEE 802.22 standard group. The WRAN system is intended to make use of unused television (TV) broadcast channels in the TV spectrum, on a non-interfering basis, to address, as a primary objective, rural and remote areas and low population density underserved markets with performance levels similar to those of broadband access technologies serving urban and suburban areas. In addition, the WRAN system may also be able to scale to serve denser population areas where spectrum is available. Since one goal of the WRAN system is not to interfere with TV broadcasts, a critical procedure is to robustly and accurately sense the licensed TV signals that exist in the area served by the WRAN (the WRAN area).

In the United States, the TV spectrum currently comprises ATSC (Advanced Television Systems Committee) broadcast signals that co-exist with NTSC (National Television Systems Committee) NTSC broadcast signals. The ATSC broadcast signals are also referred to as digital TV (DTV) signals. Currently, NTSC transmission will cease in 2009 and, at that time, the TV spectrum will comprise only ATSC broadcast signals.

Since, as noted above, one goal of the WRAN system is to not interfere with those TV signals that exist in a particular WRAN area, it is important in a WRAN system to be able to detect ATSC broadcasts. One known method to detect an ATSC signal is to look for a small pilot signal that is a part of the ATSC signal. Such a detector is simple and includes a phase lock-loop with a very narrow bandwidth filter for extracting the ATSC pilot signal. In a WRAN system, this method provides an easy way to check if a broadcast channel is currently in use by simply checking if the ATSC detector provides an extracted ATSC pilot signal. Unfortunately, this method may not be accurate, especially in a very low signal-to-noise ratio (SNR) environment. In fact, false detection of an ATSC signal may occur if there is an interfering signal present in the band that has a spectral component in the pilot carrier position.

### SUMMARY OF THE INVENTION

We have observed that increasing the accuracy of either the timing or carrier frequency references in the receiver improves the performance of broadcast signal detection techniques (whether these techniques are coherent or non-coherent). In particular, and in accordance with the principles of the invention, a receiver comprises a tuner for tuning to one of a number of channels, a broadcast signal detector coupled to the tuner for detecting if a broadcast signal exists on at least one of the channels, wherein the tuner is calibrated as a function of a received broadcast signal.

In an illustrative embodiment of the invention, the broadcast signal is an ATSC (Advanced Television Systems Committee) signal and the receiver is a Wireless Regional Area Network (WRAN) receiver, wherein the tuner is calibrated as a function of a received ATSC signal and wherein the broadcast signal detector includes a coherent ATSC signal detector.

In another illustrative embodiment of the invention, the broadcast signal is an ATSC signal and the receiver is a WRAN receiver, wherein the tuner is calibrated as a function of a received ATSC signal and wherein the broadcast signal detector includes a non-coherent ATSC signal detector.

In another illustrative embodiment of the invention, the receiver is a Wireless Regional Area Network (WRAN) receiver and the receiver performs a method to determine a frequency band available for communications in the WRAN system. Illustratively, the receiver calibrates itself as a function of a received broadcast signal; and, after the calibration, detects if other broadcast signals exist in at least one portion of a frequency spectrum to determine an available portion of the frequency spectrum for use by the receiver.

In view of the above, and as will be apparent from reading the detailed description, other embodiments and features are also possible and fall within the principles of the invention.

### BRIEF DESCRIPTION OF THE DRAWINGS

FIG. 1 shows Table One, which lists television (TV) channels;

FIGS. 2 and 3 show Tables Two and Three, which list frequency offsets under different conditions for a received ATSC signal;

FIG. 4 shows an illustrative WRAN system in accordance with the principles of the invention;

FIG. 5 shows an illustrative receiver for use in the WRAN system of FIG. 4 in accordance with the principles of the invention;

FIG. 6 shows an illustrative flow chart for use in the WRAN system of FIG. 4 in accordance with the principles of the invention;

FIGS. 7 and 8 illustrate tuner 305 and carrier tracking loop 315 of FIG. 5;

FIGS. 9 and 10 show a format for an ATSC DTV signal; and

FIGS. 11-21 show various embodiments of ATSC signal detectors.

### DETAILED DESCRIPTION

Other than the inventive concept, the elements shown in the figures are well known and will not be described in detail. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC) is assumed. Further information on ATSC broadcast signals can be found in the following ATSC standards: Digital Television Standard (A/53), Revision C, including Amendment No. 1 and Corrigendum No. 1, Doc. A/53C; and Recommended Practice: Guide to the Use of the ATSC Digital Television Standard (A/54). Likewise, other than the inventive concept, transmission concepts such as eight-level vestigial sideband (8-VSB), Quadrature Amplitude Modulation (QAM), orthogonal frequency division multiplexing (OFDM) or coded OFDM (COFDM)), and receiver components such as a radio-frequency (RF) front-end, or receiver section, such as a low noise block, tuners, and demodulators, correlators, leak integrators and squarers is assumed. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

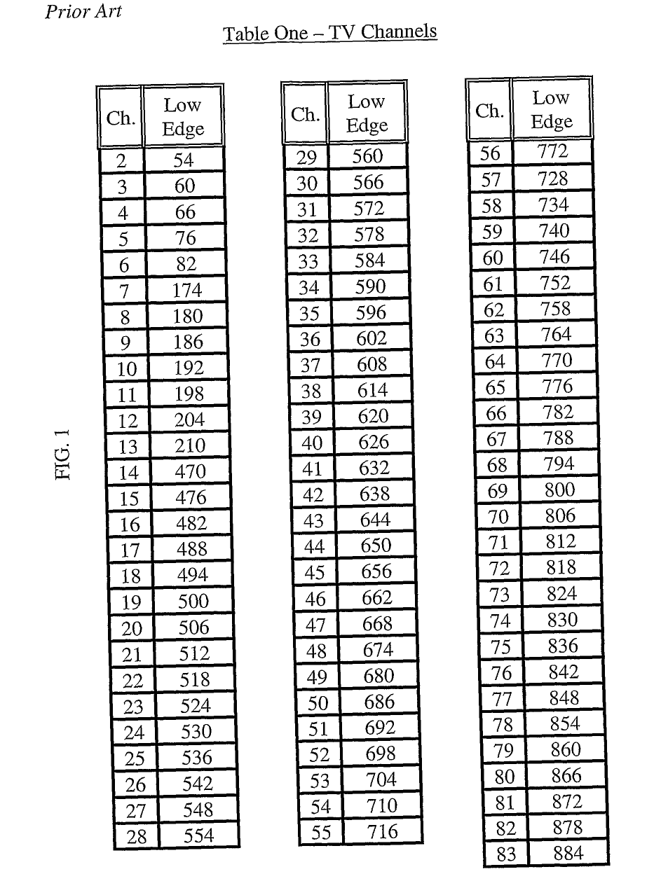

A TV spectrum for the United States as known in the art is shown in Table One of FIG. 1, which provides a list of TV channels in the very high frequency (VHF) and ultra high frequency (UHF) bands. For each TV channel, the corresponding low edge of the assigned frequency band is shown. For example, TV channel 2 starts at 54 MHz (millions of hertz), TV channel 37 starts at 608 MHz and TV channel 68 starts at 794 MHz, etc. As known in the art, each TV channel, or band, occupies 6 MHz of bandwidth. As such, TV channel 2 covers the frequency spectrum (or range) 54 MHz to 60 MHz, TV channel 37 covers the band from 608 MHz to 614 MHz and TV channel 68 covers the band from 794 MHz to 800 MHz, etc. As noted earlier, a WRAN system makes use of unused television (TV) broadcast channels in the TV spectrum. In this regard, the WRAN system performs “channel sensing” to determine which of these TV channels are actually active (or “incumbent”) in the WRAN area in order to determine that portion of the TV spectrum that is actually available for use by the WRAN system.

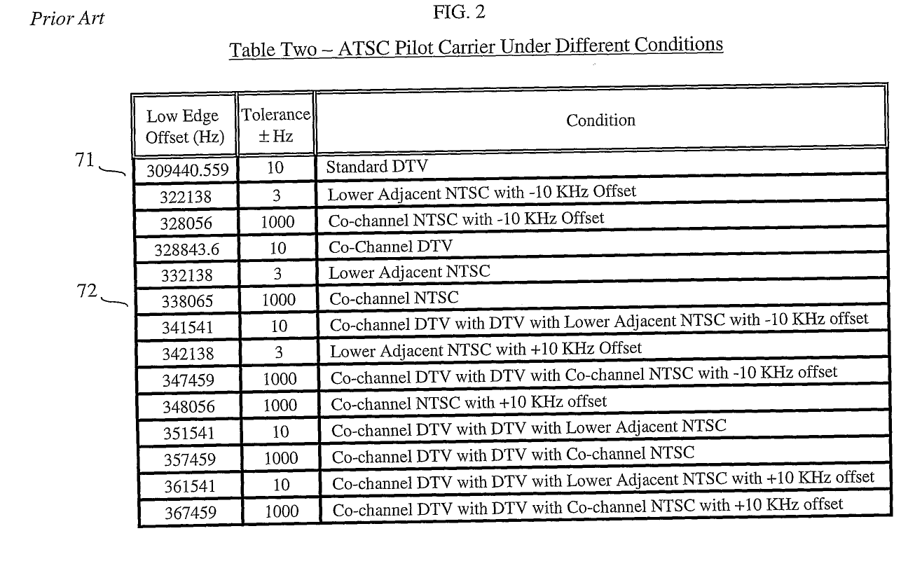

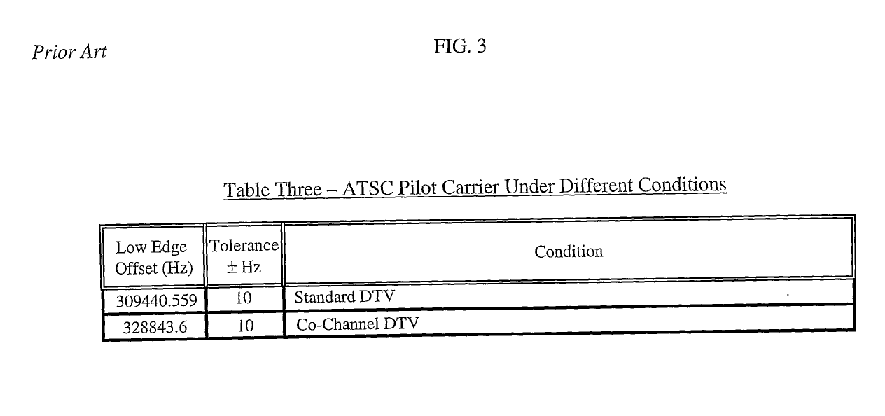

In addition to the TV spectrum shown in FIG. 1, a particular ATSC DTV signal in a particular channel may also be affected by NTSC signals, or even other ATSC signals, that are co-located (i.e., in the same channel) or adjacent to the ATSC signal (e.g., in the next lower, or upper, channel). This is illustrated in Table Two, of FIG. 2, in the context of an ATSC pilot signal as affected by different interfering conditions. For example, the first row, 71, of Table Two provides the low edge offset in Hz of an ATSC pilot signal if there is no co-located or adjacent interference from another NTSC or ATSC signal. This corresponds to the ATSC pilot signal as defined in the above-noted ATSC standards, i.e., the pilot signal occurs at 309.44059 KHz (thousands of Hertz) above the low edge of the particular channel. (Again, Table One, of FIG. 1, provides the low edge value in MHz for each channel.) However, reference to the row labeled 72, of Table Two, provides the low edge offset of an ATSC pilot signal when there is a co-located NTSC signal. In such a situation, an ATSC receiver will receive an ATSC pilot signal that is 338.065 KHz above the low edge. In the context of NTSC and ATSC broadcasts, it can be observed from Table Two that the total number of possible offsets is 14. However, once NTSC transmission is discontinued, the total number of possible offsets decreases to two, with a tolerance of 10 Hz, which is illustrated in Table Three, of FIG. 3.

Since it is important for any channel sensing to be accurate, we have observed that increasing the accuracy of either the timing or carrier frequency references in a receiver improves the performance of signal detection, or channel sensing, techniques (whether these techniques are coherent or non-coherent). In particular, and in accordance with the principles of the invention, a receiver comprises a tuner for tuning to one of a number of channels, a broadcast signal detector coupled to the tuner for detecting if a broadcast signal exists on at least one of the channels, wherein the tuner is calibrated as a function of a received broadcast signal. An illustrative embodiment of the invention is described in the context of using an existing ATSC channel as a reference. However, the inventive concept is not so limited.

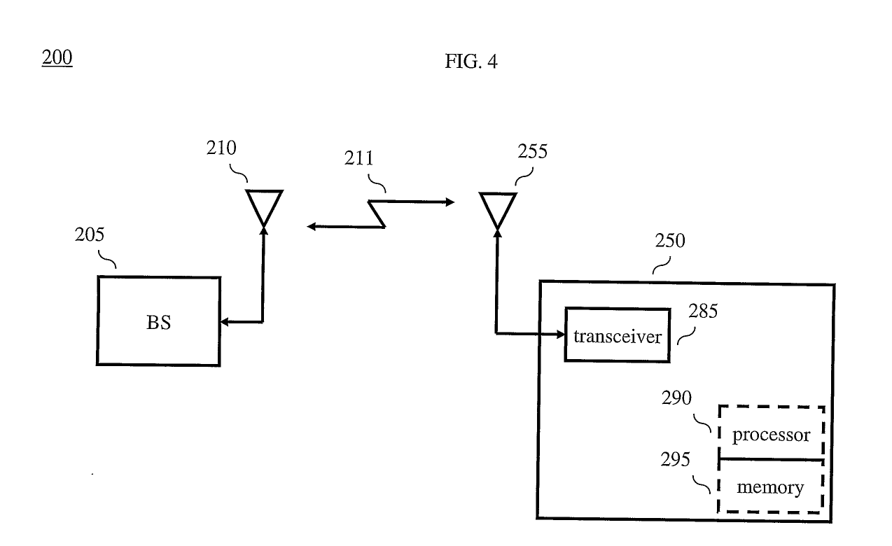

An illustrative Wireless Regional Area Network (WRAN) system 200 incorporating the principles of the invention is shown in FIG. 4. WRAN system 200 serves a geographical area (the WRAN area) (not shown in FIG. 4). In general terms, a WRAN system comprises at least one base station (BS) 205 that communicates with one, or more, customer premise equipment (CPE) 250. The latter may be stationary. CPE 250 is a processor-based system and includes one, or more, processors and associated memory as represented by processor 290 and memory 295 shown in the form of dashed boxes in FIG. 4. In this context, computer programs, or software, are stored in memory 295 for execution by processor 290. The latter is representative of one, or more, stored-program control processors and these do not have to be dedicated to the transmitter function, e.g., processor 290 may also control other functions of CPE 250. Memory 295 is representative of any storage device, e.g., random-access memory (RAM), read-only memory (ROM), etc.; may be internal and/or external to CPE 250; and is volatile and/or non-volatile as necessary. The physical layer of communication between BS 205 and CPE 250, via antennas 210 and 255, is illustratively OFDM-based via transceiver 285 and is represented by arrows 211. To enter a WRAN network, CPE 250 may first “associate” with BS 210. During this association, CPE 250 transmits information, via transceiver 285, on the capability of CPE 250 to BS 205 via a control channel (not shown). The reported capability includes, e.g., minimum and maximum transmission power, and a supported channel list for transmission and receiving. In this regard, CPE 250 performs “channel sensing” in accordance with the principles of the invention to determine which TV channels are not active in the WRAN area. The resulting available channel list for use in WRAN communications is then provided to BS 205.

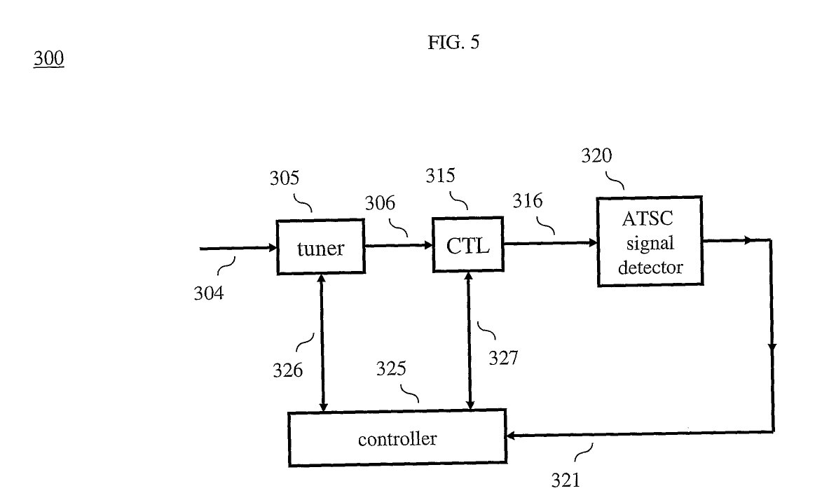

An illustrative portion of a receiver 300 for use in CPE 250 is shown in FIG. 5. Only that portion of receiver 300 relevant to the inventive concept is shown. Receiver 300 comprises tuner 305, carrier tracking loop (CTL) 315, ATSC signal detector 320 and controller 325. The latter is representative of one, or more, stored-program control processors, e.g., a microprocessor (such as processor 290), and these do not have to be dedicated to the inventive concept, e.g., controller 325 may also control other functions of receiver 300. In addition, receiver 300 includes memory (such as memory 295), e.g., random-access memory (RAM), read-only memory (ROM), etc.; and may be a part of, or separate from, controller 325. For simplicity, some elements are not shown in FIG. 5, such as an automatic gain control (AGC) element, an analog-to-digital converter (ADC) if the processing is in the digital domain, and additional filtering. Other than the inventive concept, these elements would be readily apparent to one skilled in the art. In this regard, the embodiments described herein may be implemented in the analog or digital domains. Further, those skilled in the art would recognize that some of the processing may involve complex signal paths as necessary.

Before describing the inventive concept, the general operation of receiver 300 is as follows. An input signal 304 (e.g., received via antenna 255 of FIG. 4) is applied to tuner 305. Input signal 304 represents a digital VSB modulated signal in accordance with the above-mentioned “ATSC Digital Television Standard” and transmitted on one of the channels shown in Table One of FIG. 1. Tuner 305 is tuned to different ones of the channels by controller 325 via bidirectional signal path 326 to select particular TV channels and provide a downconverted signal 306 centered at a specific IF (Intermediate Frequency). Signal 306 is applied to CTL 315, which processes signal 306 to both remove any frequency offsets (such as between the local oscillator (LO) of the transmitter and LO of the receiver) and to demodulate the received ATSC VSB signal down to baseband from an intermediate frequency (IF) or near baseband frequency (e.g., see, United States Advanced Television Systems Committee, “Guide to the Use of the ATSC Digital Television Standard”, Document A/54, Oct. 4, 1995; and U.S. Pat. No. 6,233,295 issued May 15, 2001 to Wang, entitled “Segment Sync Recovery Network for an HDTV Receiver”). CTL 315 provides signal 316 to ATSC signal detector 320, which processes signal 316 (described further below) to determine if signal 316 is an ATSC signal. ATSC signal detector 320 provides the resulting information to controller 325 via path 321.

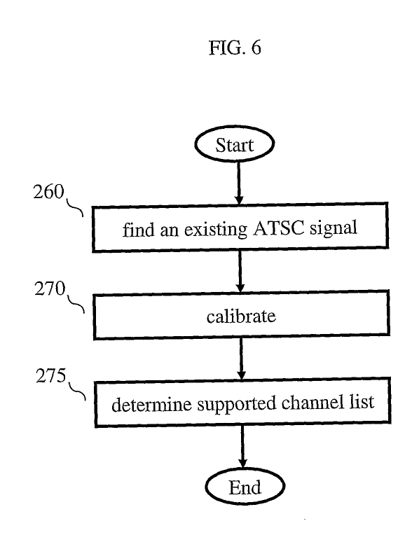

Turning now to FIG. 6, an illustrative flow chart for use in receiver 300 in accordance with the principles of the invention is shown. In particular, the detection of the presence of ATSC DTV signals in the VHF and UHF TV bands at signal levels below those required to demodulate a usable signal can be enhanced by having precise carrier and timing offset information. Illustratively, the stability and known frequency allocation of DTV channels themselves are used to provide this information. As specified in the above-noted ATSC A/54A ATSC Recommended Practice, carrier frequencies are specified to be at least within 1 KHz (thousands of hertz), and tighter tolerances are recommended for good practice. In this regard, in step 260, controller 325 first scans the known TV channels, such as illustrated in Table One of FIG. 1, for an existing, easily identifiable, ATSC signal. In particular, controller 325 controls tuner 305 to select each one of the TV channels. The resulting signals (if any) are processed by ATSC signal detector 320 (described further below) and the results provided to controller 325 via path 321. Preferably, controller 325 looks for the strongest ATSC signal currently broadcasting in the WRAN area. However, controller 325 may stop at the first detected ATSC signal.

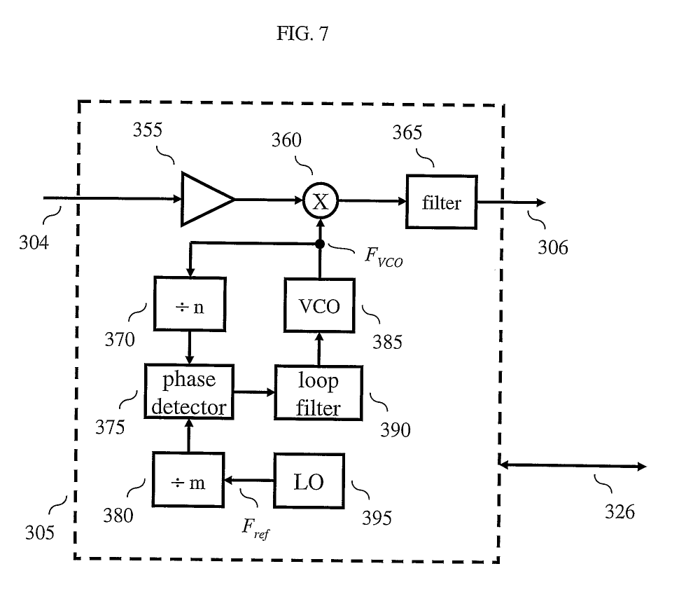

Turning briefly to FIG. 7, an illustrative block diagram of tuner 305 is shown. Tuner 305 comprises amplifier 355, multiplier 360, filter 365, divide-by-n element 370, voltage controlled oscillator (VCO) 385, phase detector 375, loop filter 390, divide-by-m element 380 and local oscillator (LO) 395. Other than the inventive concept, the elements of tuner 305 are well-known and not described further herein. In general, the following relationship holds between the signals provided by LO 395 and VCO 385:

$$\frac{{F}_{ref}}{m} = \frac{{F}_{VCO}}{n} , \qquad ( 1 )$$

where F_{ref} is the reference frequency provided by LO 395, F_{VCO} is the frequency provided by VCO 385, it is the value of the divisor represented by divide-by-n element 370 and m is the value of the divisor represented by divide-by-m element 380. Equation (1) can be rewritten as:

$${F}_{VCO} = n \frac{{F}_{ref}}{m} = n {F}_{step} . \qquad ( 2 )$$

It can be observed from equation (2) that F_{VCO} can be set to different ATSC DTV bands by appropriate values of n, as set by controller 325 (step 260 of FIG. 6) via path 326. However, and as noted above, receiver 300 includes CTL 315, which removes any frequency offsets, F_{offset}. There are two frequency offsets of note. The first is the error caused by frequency differences between LO 395 and the transmitter frequency reference. The second is the error caused by the value used for Fₛₜₑₚ since the actual frequency, F_{ref}, provided by LO 395 is only approximately known within a given tolerance of the local oscillator. As such, F_{offset} includes both the error from the value of nFₛₜₑₚ to the selected channel and the error caused by frequency differences in the local frequency reference and the transmitter frequency reference.

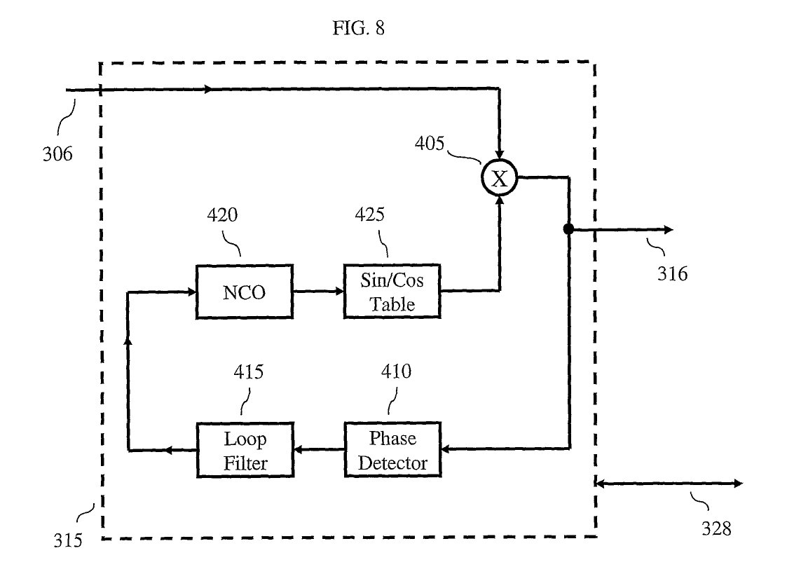

Referring now to FIG. 8, an illustrative block diagram of CTL 315 is shown. CTL 315 comprises multiplier 405, phase detector 410, loop filter 415, numerically controlled oscillator (NCO) 420 and Sin/Cos Table 425. Other than the inventive concept, the elements of CTL 315 are well-known and not described further herein. NCO 420 determines F_{offset} as known in the art and these frequency offsets are removed from the received signal via Sin/Cos Table 425 and multiplier 405.

Continuing with step 270 of FIG. 6, once an existing ATSC signal is found, controller 325 calibrates receiver 300 by determining at least one related frequency (timing) characteristic from the detected ATSC signal. In particular, the general operation of receiver 300 of FIG. 5 can be represented by the following equation:

F_{c}=nFₛₜₑₚ+F_{offset}. (3)

where F_{c} represents the frequency of the pilot signal of the detected ATSC signal. With regard to the value for F_{offset} in equation (3), controller 325 determines this value by simply accessing the associated data in NCO 420, via bidirectional path 327. However, while the value for n was already determined by controller 325 for the selected ATSC channel, the actual value of Fₛₜₑₚ is unknown. However, equation (3) can be rewritten as:

$${F}_{step} = \frac{{F}_{c} - {F}_{offset}}{n} . \qquad ( 4 )$$

While this solution seems straightforward, it should be recalled that the value for F_{c} is not uniquely determined as suggested by Table One of FIG. 1. Rather, the detected ATSC DTV signal may be affected by other NTSC or ATSC signals as shown in Table Two of FIG. 2 and Table Three of FIG. 3. If there are NTSC and ATSC transmissions in the WRAN region, then 14 possible offsets must be taken account as shown in Table Two, of FIG. 2. However, if there are no NTSC transmissions in the WRAN region, then only 2 offsets must be taken into account as shown in Table Three, of FIG. 3. For simplicity, it is assumed that there are no NTSC transmissions and only Table Three is used for this example.

As such, using the values from Table One and Table Three (e.g., stored in the earlier-noted memory), controller 325 performs two calculations to determine different values for Fₛₜₑₚ:

$$\begin{matrix}{F}_{step}^{( 1 )} = \frac{{F}_{C}^{( 1 )} - {F}_{offset}}{n} , & ( 4 a ) \\ {F}_{step}^{( 2 )} = \frac{{F}_{C}^{( 2 )} - {F}_{offset}}{n} , & ( 4 b )\end{matrix}$$

where F_{C}⁽¹⁾ represents the low band edge from Table One for the selected ATSC channel plus the low band edge offset from the first row of Table Three; and F_{C}⁽²⁾ represents the low band edge from Table One for the selected ATSC channel plus the low band edge offset from the second row of Table Three. As a result, controller 325 determines two possible values for Fₛₜₑₚ for use in receiver 300. Thus, in step 270, controller 325 determines tuning parameters for use in calibrating receiver 300.

Finally, in step 275, controller 325 scans the TV spectrum to determine the available channel list, which comprises one, or more, TV channels that are not being used and, as such, are available for supporting WRAN communications. For each channel that is selected by controller 325 (e.g., from the list of Table One), the observations with respect to equations (3), (4), (4a) and (4b) still apply. In other words, for each selected channel the offsets shown in Table Three must be taken into account. Since there are two offsets shown in Table Three and there are two possible values for Fₛₜₑₚ as determined in step 270 (equations (4a) and (4b)), four scans are performed. (If the offsets listed in Table Two were used, there would be 14² scans or 196 scans). For example, in the first scan, controller 325 sets tuner 305, via path 326, to different values for n for each of the ATSC channels. Controller 325 determines the values for n and F_{offset} from:

$$n = ⌊ \frac{{F}_{c}}{{F}_{step}} ⌋ and {F}_{offset} = {F}_{c} - n {F}_{step} , \qquad ( 5 )$$

where the value for Fₛₜₑₚ is equal to the determined value for F_{Step}⁽¹⁾ and the value for F_{c} is equal to the low band edge from Table One for the selected ATSC channel plus the low band edge offset from the first row of Table Three. (It should also be noted that instead of a “floor” function in equation (5), a “ceiling” function can be used.) However, for the second scan, while the value for Fₛₜₑₚ is still equal to the determined value for F_{Step}⁽¹⁾, the value for F_{c} is now changed to be equal to the low band edge from Table One for the selected ATSC channel plus the low band edge offset from the second row of Table Three. The third and fourth scans are similar except that the value for Fₛₜₑₚ is now set equal to the determined value for F_{Step}⁽²⁾. During each of these scans, as tuner 305 is tuned to provide a selected channel, ATSC signal detector 320 processes the received signals to determine if an ATSC signal is present on the currently selected channel. Data, or information, as to the presence of an ATSC signal is provided to controller 325 via path 321. From this information, controller 325 builds the available channel list. Thus, and in accordance with the principles of the invention, the stability and known frequency allocation of DTV channels themselves are used to calibrate receiver 300 in order to enhance detection of low SNR ATSC DTV signals. As such, in step 275, receiver 300 is able to scan for ATSC signals that may be present even in a very low SNR environment because of the precise frequency information (F_{offset} and the various values for Fₛₜₑₚ) determined in step 270. The target sensitivity is to detect ATSC signals with a signal strength of −116 dBm (decibels relative to a power level of one milliwatt). This is more than 30 dB (decibels) below the threshold of visibility (ToV). It should be noted that, depending on the drift characteristics of the local oscillator, it may be necessary to periodically re-calibrate. It should also be noted that further variations to the above-described method can also be implemented. For example, the ATSC signal detected in step 260 can be excluded from the scans performed in step 275. Further, any re-calibrations can immediately be performed by tuning to the identified ATSC signal from step 260 without having to perform step 260 again. Also, once an ATSC signal is detected in step 275, the associated band can be excluded from any subsequent scans.

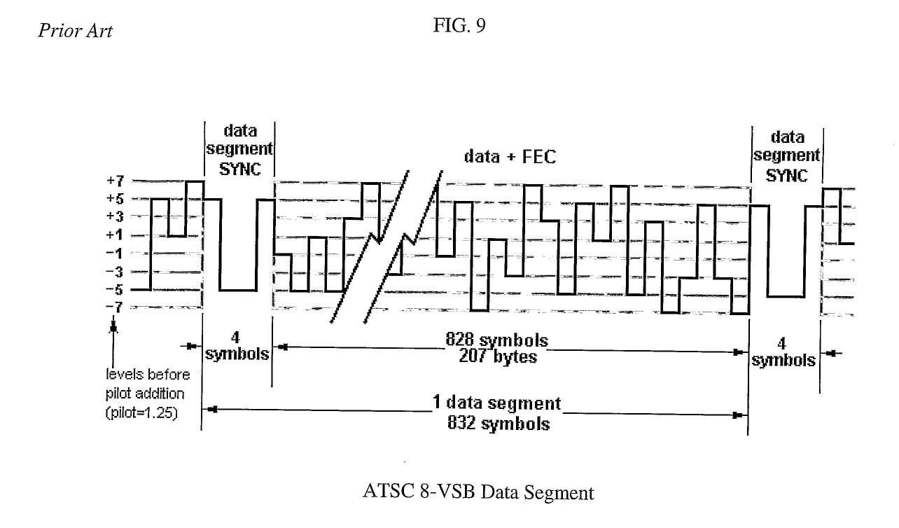

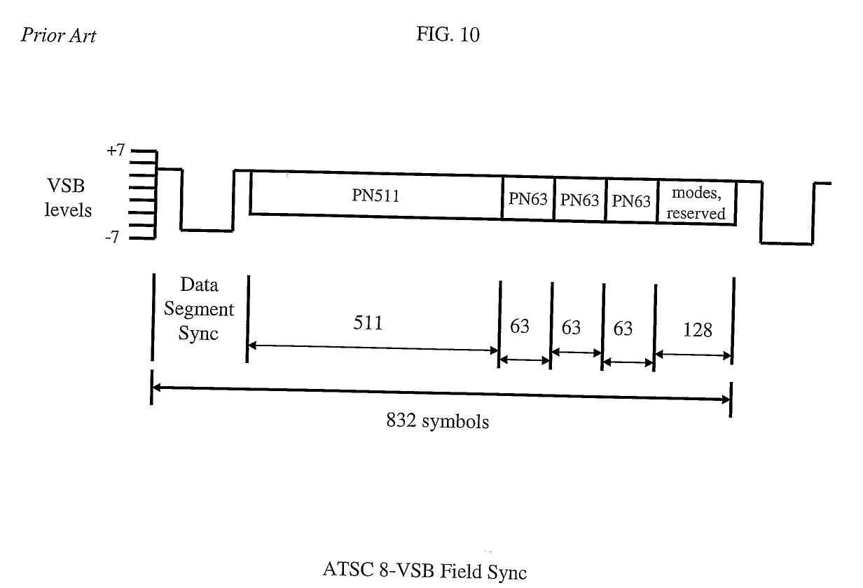

As noted above, receiver 300 includes an ATSC signal detector 320. One example of ATSC signal detector 320 takes advantage of the format of an ATSC DTV signal. DTV data is modulated using 8-VSB (vestigial sideband). In particular, for a receiver operating in low SNR environments, segment sync symbols and field sync symbols embedded within an ATSC DTV signal are utilized by the receiver to improve the probability of accurately detecting the presence of an ATSC DTV signal, thus reducing the false alarm probability. In an ATSC DTV signal, besides the eight-level digital data stream, a two-level (binary) four-symbol data segment sync is inserted at the beginning of each data segment. An ATSC data segment is shown in FIG. 9. The ATSC data segment consists of 832 symbols: four symbols for data segment sync, and 828 data symbols. The data segment sync pattern is a binary 1001 pattern, as can be observed from FIG. 9. Multiple data segments (313 segments) comprise an ATSC data field, which comprises a total of 260,416 symbols (832×313). The first data segment in a data field is called the field sync segment. The structure of the field sync segment is shown in FIG. 10, where each symbol represents one bit of data (two-level). In the field sync segment, a pseudo-random sequence of 511 bits (PN511) immediately follows the data segment sync. After the PN511 sequence, there are three identical pseudo-random sequences of 63 bits (PN63) concatenated together, with the second PN63 sequence being inverted every other data field.

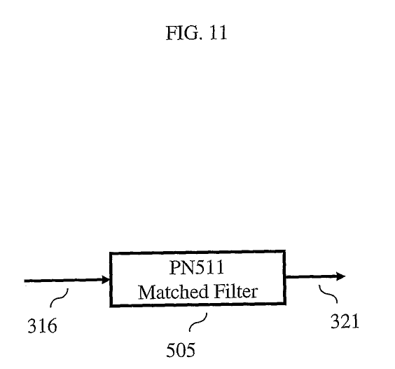

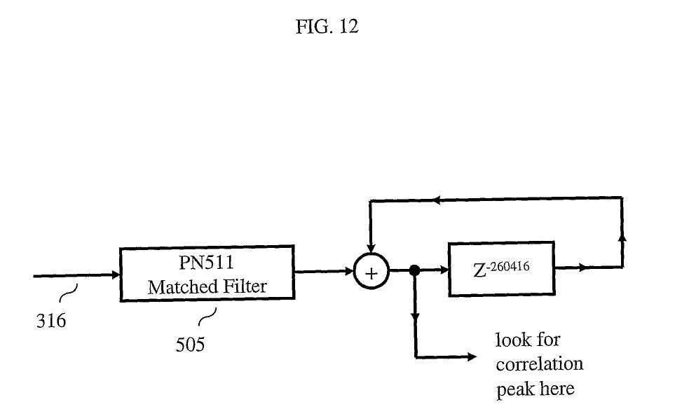

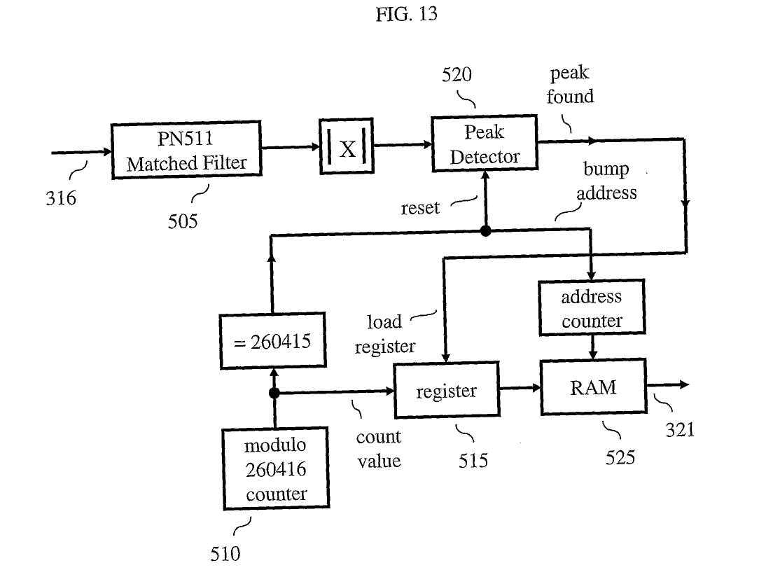

In view of the above, one embodiment of ATSC signal detector 320 is shown in FIG. 11. In this embodiment, ATSC signal detector 320 comprises a matched filter 505 that matches to the above-noted PN511 sequence for identifying the presence of the PN511 sequence. Another variation is shown in FIG. 12. In this figure, the output from the matched filter is accumulated multiple times to decide if an outstanding peak exists. This improves the detection probability and reduces the false-alarm probability. A drawback to the embodiment of FIG. 12 is that a large memory is required. Another approach is shown in FIG. 13. In this approach, the peak value is detected (520), along with its position within one data field (510, 515). It should be noted that the reset signal also increments the address counter (i.e., “bumps the address”), for storing the results in different locations of RAM 525. As such, the results are stored for multiple data fields in RAM 525. If the peak positions are the same for a certain percentage of the data fields, then it is decided that a DTV signal is present in the DTV channel.

Another method to detect the presence of an ATSC DTV signal is to use the data segment sync. Since the data segment sync repeats every data segment, it is usually used for timing recovery. This timing recovery method is outlined in the above-noted Recommended Practice: Guide to the Use of the ATSC Digital Television Standard (A/54). However, the data segment sync can also be used to detect the presence of a DTV signal using the timing recovery circuit. If the timing recovery circuit provides an indication of timing lock, it ensures the presence of the DTV signal with high confidence. This method will work even if the initial local symbol clock is not close to the transmitter symbol clock, as long as the clock offset is within the pull-in range of the timing recovery circuitry. However, it should be noted that since the useful range was down to 0 dB SNR, there needs to be an additional 15 dB improvement to reach the above-noted detection goal of −116 dBm.

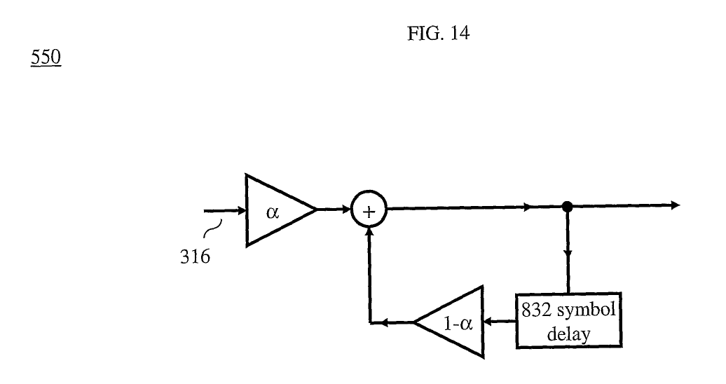

Another approach that can be used to detect an ATSC signal is to process the segment syncs independent of the timing recovery mechanism employed. This is illustrated in FIG. 14, which shows a coherent segment sync detector that uses an infinite impulse response (IIR) filter 550 comprising a leaky integrator (where the symbol, α, is a predefined constant). The use of an IIR filter builds up the timing peak for detection by reinforcing information that occurs with a repetition period of one segment. This assumes that the carrier offset and timing offset are small.

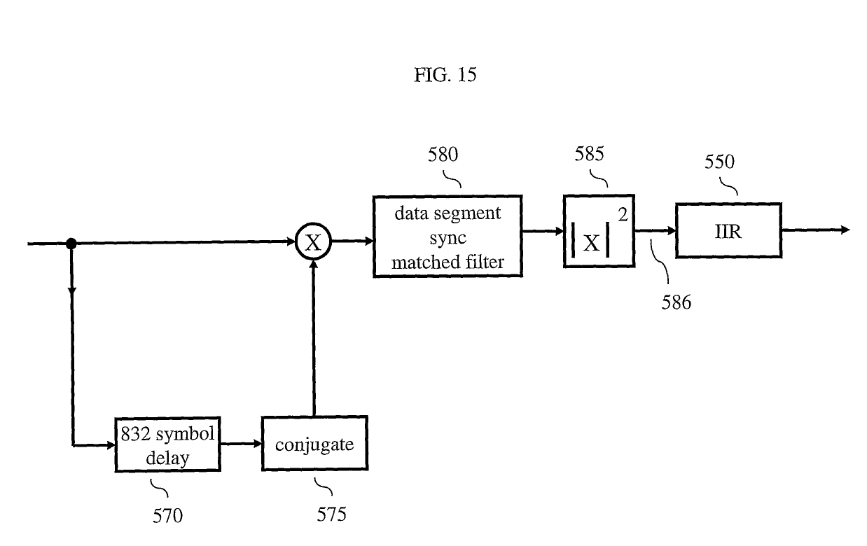

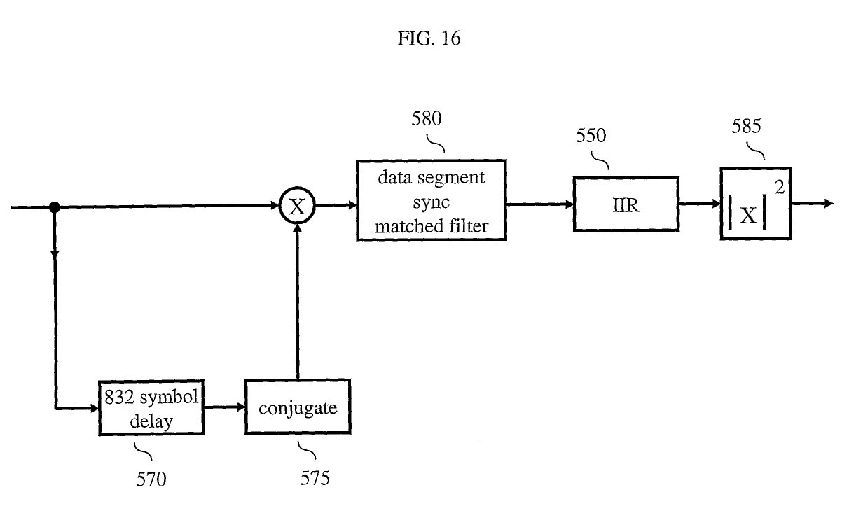

Other than the above-described coherent methods for detecting an ATSC signal, non-coherent approaches may also be used, i.e., down-conversion to baseband via use of the pilot carrier is not required. This is advantageous since robust extraction of the pilot can be problematic in low SNR environments. One illustrative non-coherent segment sync detector is shown in FIG. 15, which illustrates a delay line structure. The input signal is multiplied by a delayed, conjugated version of itself (570, 575). The result is applied to a filter for matching to the data segment sync (data segment sync matched filter 580). The conjugation ensures that any carrier offset will not affect the amplitude following the matched filter. Alternatively, an integrate-and-dump approach might be taken. Following the matched filter 580, the magnitude (585) of the signal is taken (or more easily, the magnitude squared is taken as I²+Q², where I and Q are in-phase and quadrature components, respectively, of the signal out of the matched filter). This magnitude value (586) can be examined directly to see if an outstanding peak exists indicating the presence of a DTV signal. Alternatively, as indicated in FIG. 15, signal 586 can be further refined by processing with IIR filter 550 in order to improve the robustness of the estimate over multiple segments. An alternative embodiment is shown in FIG. 16. In this embodiment, the integration (580) is performed coherently (i.e., keeping the phase information), after which the magnitude (585) of the signal is taken.

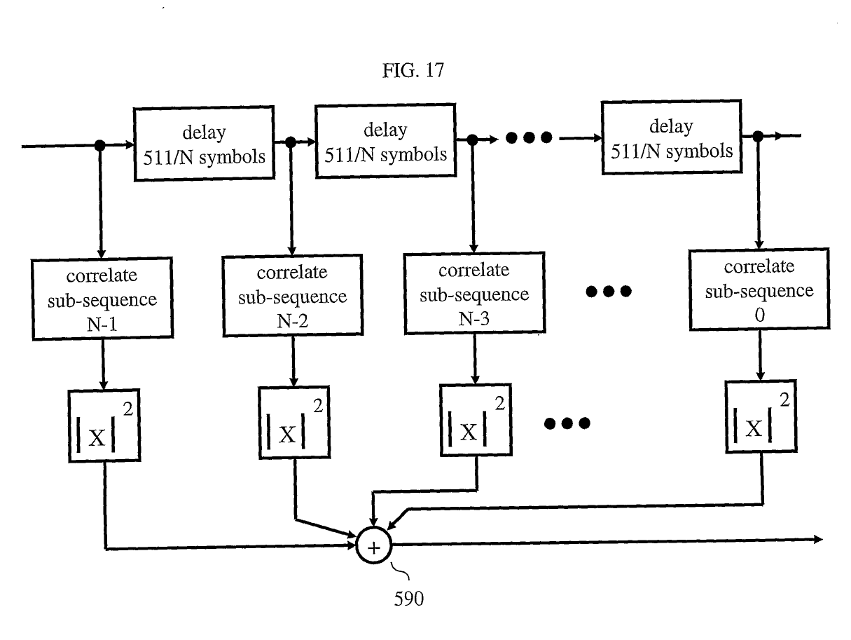

Similarly to the earlier-described embodiments operating at baseband, other non-coherent embodiments may also utilize the longer PN511 sequences found within the field sync. However, it should be noted that some modifications may have to be made to accommodate the frequency offset. For example, if the PN511 sequence is to be used as an indicator of the ATSC signal, there may be several correlators used simultaneously to detect its presence. Consider the case where the frequency offset is such that the carrier undergoes one complete cycle or rotation during the PN511 sequence. In such a case, the matched correlator output between the input signal and a reference PN511 sequence would sum to zero. However, if the PN511 sequence is broken into N parts, each part would have appreciable energy, as the carrier would only rotate by 1/N cycles during each part. Therefore, a non-coherent correlator approach can be utilized advantageously by breaking the long correlator into smaller sequences, and approaching each sub-sequence with a non-coherent correlator, as shown in FIG. 17. In this figure, the sequence to be correlated is broken into N sub-sequences, numbered from 0 to N−1. The input data is delayed such that the correlator outputs are combined (590) to yield a usable non-coherent combination.

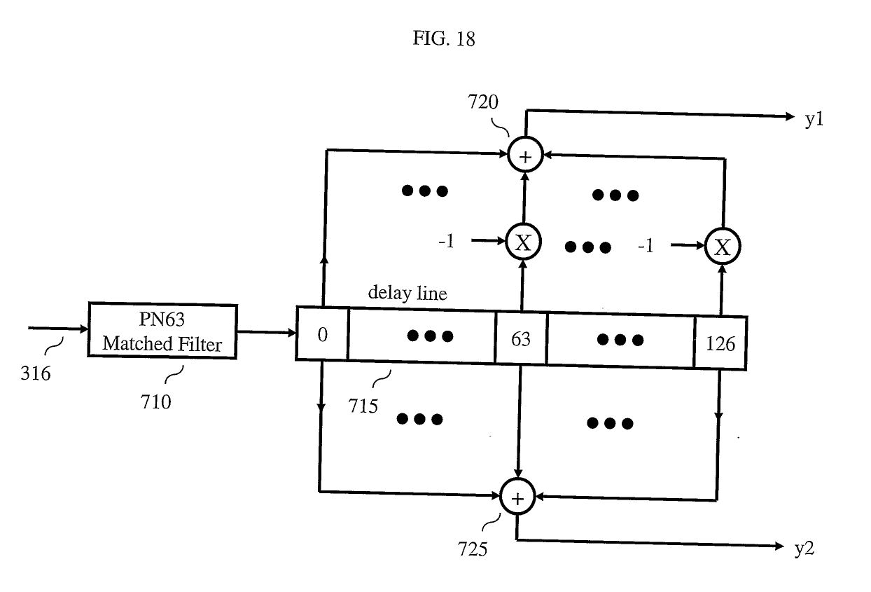

Another illustrative embodiment of an ATSC signal detector is shown in FIG. 18. In order to reduce the complexity of the ATSC signal detector, the ATSC signal detector of FIG. 18 uses a matched filter (710) that matches to the PN63 sequence. The output signal from matched filter 710 is applied to delay line 715. In the embodiment of FIG. 18, a coherent combining approach is used. Since the middle PN63 is inverted on every other data field sync, two outputs y1 and y2 are generated via adders 720 and 725, corresponding to these two data field sync cases. As can be observed from FIG. 18, the processing path for output y1 includes multipliers to invert the middle PN63 before combination via adder 720. It should be noted that the embodiment of FIG. 18 performs peak detection. If there is an outstanding peak appearing in either y1 or y2, then it is assumed that an ATSC DTV signal is present.

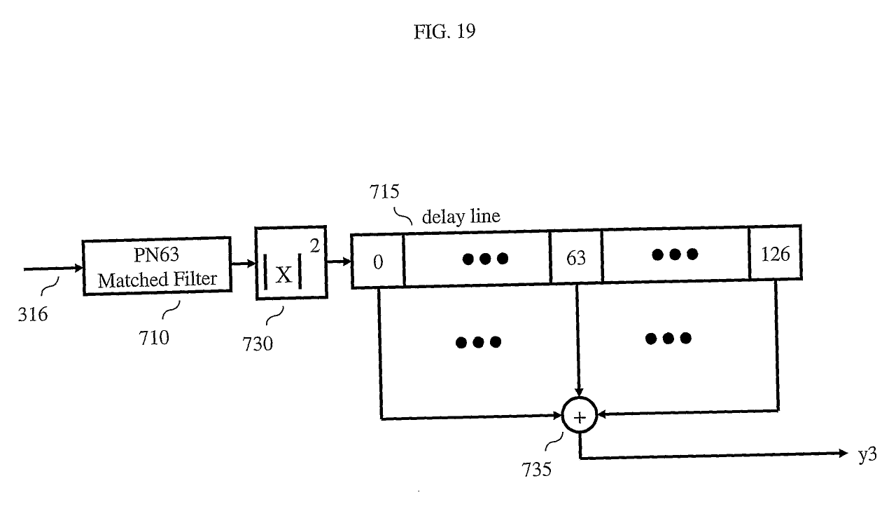

An alternative embodiment of an ATSC signal detector that matches to the PN63 sequence is shown in FIG. 19. This embodiment is similar to that shown in FIG. 18, except that the output signal of matched filter 710 is applied first to element 730, which computes the square magnitude of the signal. This is an example of a non-coherent combining approach. As in FIG. 18, the embodiment of FIG. 19 performs peak detection. Adder 735 combines the various elements of delay line 715 to provide output signal y3. If there is an outstanding peak appearing in y3, then it is assumed that an ATSC DTV signal is present. It should be noted that when the carrier offset is relatively large, the non-coherent combining approach of FIG. 19 may be more suitable than the coherent combining one. Also, it should be noted that element 730 can simply determine the magnitude of the signal.

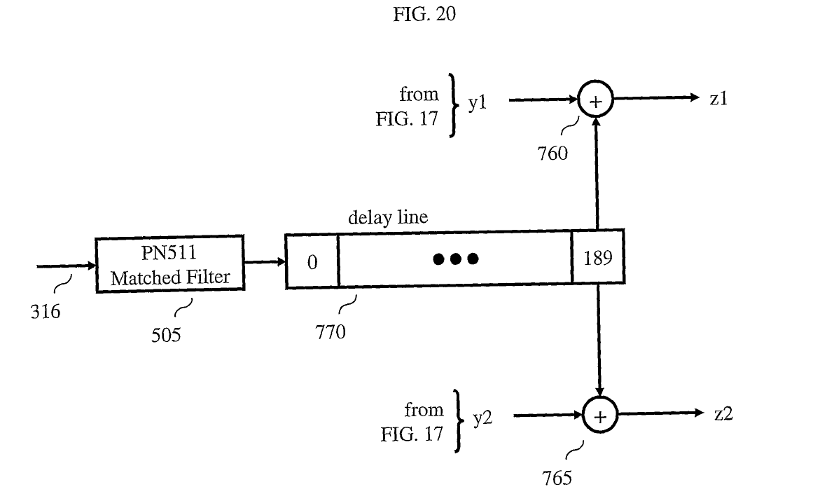

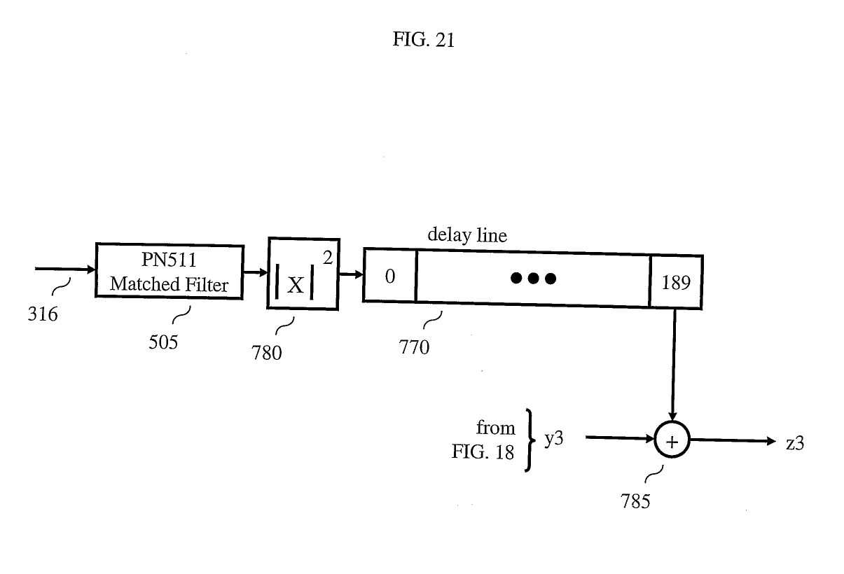

Yet additional variations are shown in FIGS. 20 and 21. In these illustrative embodiments, the PN511 and PN63 sequences are used together for ATSC signal detection. Turning first to the embodiment shown in FIG. 20, the signals y1 and y2 are generated as described above with respect to the embodiment of FIG. 18 for detecting a PN63 sequence. In addition, the output from matched filter 505 (which matches to the PN511 sequence) is applied to delay line 770, which stores data over the time interval for the three PN63 sequences. The embodiment of FIG. 20 performs peak detection. If there is an outstanding peak appearing in either z1 or z2, (provided via adders 760 and 765, respectively) then it is assumed that an ATSC DTV signal is present.

Turning now to FIG. 21, the embodiment of FIG. 21 also combines detection of the PN511 sequence with detection of the PN63 sequence as shown in FIG. 19. In this embodiment, the output signal of matched filter 505 is applied first to element 780, which computes the square magnitude of the signal. This is an example of another non-coherent combining approach. As in FIG. 20, the embodiment of FIG. 21 performs peak detection. Adder 785 combines the various elements of delay line 770 with output signal y3 to provide output signal z3. If there is an outstanding peak appearing in z3, then it is assumed that an ATSC DTV signal is present. Also, it should be noted that element 780 can simply determine the magnitude of the signal.

Other variations to the above are possible. For example, the PN63 and PN511 matched filters can be cascaded, in order to make use of their inherent delay-line structure to reduce the amount of additional delay line needed. In another embodiment, three PN63 matched filters can be employed rather than a single PN63 matched filter plus delay lines. This can be done with or without use of a PN511 matched filter.

As described above, the performance of a broadcast signal detector is enhanced by first calibrating the tuner to a received broadcast signal before scanning the spectrum for other broadcast signals. Thus, in the context of a WRAN system, it is possible to detect the presence of ATSC DTV signals in low signal-to-noise environments with high confidence. It should be noted that although the receiver of FIG. 5 is described in the context of CPE 250 of FIG. 4, the invention is not so limited and also applies to, e.g., a receiver of BS 205 that may perform channel sensing. Further, although the receiver of FIG. 5 is described in the context of a WRAN system, the invention is not so limited and applies to any receiver that performs channel sensing.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of the steps shown in, e.g., FIG. 6, etc. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. Apparatus comprising:
a tuner for tuning to one of a number of channels; and
a broadcast signal detector coupled to the tuner for detecting if a broadcast signal exists on at least one of the channels;
wherein the tuner is calibrated as a function of a received broadcast signal.

2. The apparatus of claim 1, further comprising:
a processor coupled to the broadcast signal detector for forming a available channel list comprising those ones of the number of channels upon which a broadcast signal was not detected.

3. The apparatus of claim 2, wherein the apparatus is a receiver for receiving signals from a Wireless Regional Area Network (WRAN).

4. The apparatus of claim 1, further comprising:
a processor coupled to the broadcast signal detector for determining tuning parameters for use in calibrating the tuner from a number of possible offsets for the received broadcast signal.

5. The apparatus of claim 4, further comprising:
a memory for storing the number of possible offsets.

6. The apparatus of claim 1, wherein the broadcast signal detector is coherent.

7. The apparatus of claim 1, wherein the broadcast signal detector is non-coherent.

8. The apparatus of claim 1, wherein the broadcast signal is an ATSC (Advanced Television Systems Committee) signal.

9. A method for use in a receiver, the method comprising:
calibrating the receiver as a function of a received broadcast signal; and
after performing the calibrating step, detecting if other broadcast signals exist in at least one portion of a frequency spectrum to determine an available portion of the frequency spectrum for use by the receiver.

10. The method of claim 9, wherein the calibrating step includes:
determining tuning parameters for use in calibrating the receiver from a number of possible offsets for the received broadcast signal.

11. The method of claim 10, wherein the detecting step includes:
performing multiple scans of the at least one portion of the frequency spectrum at each one of the number of possible offsets.

12. The method of claim 9, wherein the detecting step is coherent.

13. The method of claim 9, wherein the detecting step is non-coherent.

14. The method of claim 9, wherein the broadcast signal is an ATSC (Advanced Television Systems Committee) signal.

15. The method of claim 9, further comprising the step of:
receiving a Wireless Regional Area Network (WRAN) signal in the determined available portion of the frequency spectrum.
